(19) United States
(12) Patent Application Publication
(10) Pub. No.: US 2004/0066170 A1
(43) Pub. Date: Apr. 8, 2004

(54) Cycle battery output control device

(76) Inventor: Lin Wen-Fei, Hsin Chu City (TW)

Correspondence Address: LIN WEN-FEI, P.O. BOX 7-820, TAIPEI, TW

(21) Appl. No.: 10/265,447

(22) Filed: Oct. 7, 2002

(51) Int. Cl. H02J 7/00

(52) U.S. Cl. 320/130

(57) ABSTRACT

The present invention relates to a cycle battery output control device, more particularly to a control device precisely monitoring the battery output and effectively extending its life, comprising a central control module, a battery module, an output module, a memory module, and a data module; characterized in that a low-voltage detecting unit of the central control module acts as a switch between battery modules to timely control the function of the output module, and count the number of times that the detecting unit monitors the cycle switching output route with the previous battery at any time to assure the exhaustion of the electricity storage of the previous battery module, and working with the voltage indicating unit to timely turn on or off the light and correctly indicate the exhaustion of electricity storage of the battery module and the charging indicating unit to alert a blinking light to show the status of switching to the last battery module for the cycle switch in order to attain the effect of providing the accurate information on the remaining electric power of the battery and the full use of the battery and timely indication of the cycle switching battery output, as well as the effect of increasing the saturated charging and extending the life of use.

### BACKGROUND OF THE INVENTION

1. Field of the Invention

The present invention relates to a cycle battery output control device, more particularly to a control device precisely monitoring the battery output and effectively extending the life of the battery.

2. Description of the Prior Art

In the 21^{st} century, the electronic technological era brings in all kinds of electronic products for mankind to facilitate our living, and thus the battery as the power source of these electronic products is invented; wherein the lead acid battery is applicable for ordinary motor vehicles and motorcycles that require large instant current discharge; the nickel-hydrogen battery and lithium battery are applicable for electronic industry that requires long time discharge and has no charging memory effect. However, these batteries have limitations on the electricity storage and the number of times of charging, and therefore a single product may have several battery modules connected in series or in parallel at the same time in order to maintain the long time working effect, which is the key point of the design by manufacturers. Although these batteries can enhance the time of use, yet the inconsistent quality of batteries by different manufacturers and the different charging effects.

### SUMMARY OF THE INVENTION

The primary objective of the present invention is to provide a cycle battery output control device, particularly the control device comprising a low-voltage counter detecting unit built in the central control unit, a voltage and charging indicating unit, wherein the low-voltage detecting unit is used as the battery switch to timely control the function of the output module.

The secondary objective of the present invention is to provide a cycle battery output control device that can count the number of times for the detecting unit monitoring the cycle switching output route with the previous battery at any time to assure the exhaustion of the electricity storage of the previous battery module.

Another objective of the present invention is to provide a cycle battery output control device that appropriately turns on or off the indicating light of the voltage-indicating unit to show the exhaustion of the battery module and blinks the charging indicating light to alert the situation of switching to the last battery module. Such arrangement can attain the effect of providing the users the accurate information on the remaining electric power of the battery.

Another objective of the present invention is to provide a cycle battery output control device that can use the battery module next to the previous starting battery as the starting battery module for this time provided by the memory module after the saturated battery recharge, so that each battery module can have even cycle recharge and discharge, and further optimizes the performance.

A further objective of the present invention provides a cycle battery output control device, wherein the battery module could be lead acid, nickel-hydrogen, lithium, fuel battery and their combinations in accordance with different purposes. If any of the battery modules of the battery is exhausted, the low-voltage detecting unit will skip the used-up battery the cycle switch until the used-up battery is replaced.

### BRIEF DESCRIPTION OF THE DRAWINGS

FIG. 1 is a a block diagram of the circuit of the present invention;

FIG. 2 is a control flowchart of the present invention;

FIG. 3 shows another preferred embodiment of the present invention.

### DELTAILED DESCRIPTION OF THE PREFERRED EMBODIMENT

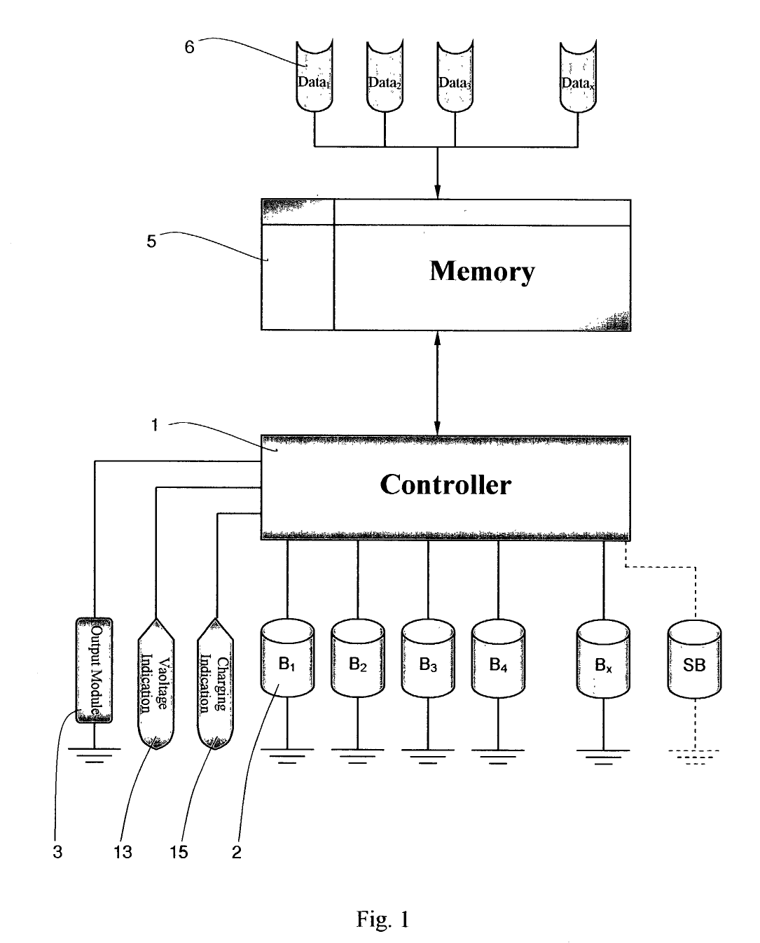

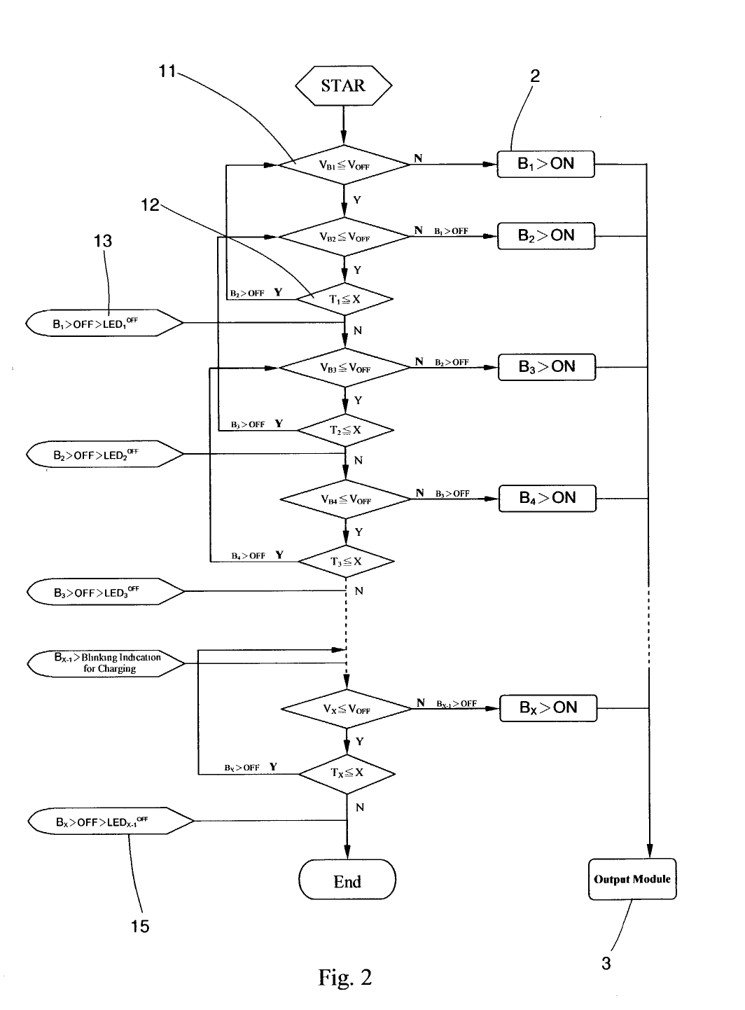

Please refer to FIGS. 1 and 2 for a cycle battery output control device according to the present invention, comprising a central control module 1, a battery module 2, an output module 3, a memory module 5, and a data module 6; the central control module 1 further comprising a built-in low-voltage detecting unit 11, a count detecting unit 12, a voltage indicating unit 13, and a charging indicating unit 15; wherein the low-voltage detecting unit 11 being used for measuring the electric energy and potential stored in each of the batteries, the count detecting unit 12 for counting the number of times of the cycle switching between adjacent batteries, the voltage indicating unit 13 for showing whether or not the battery is used up by turning on or off the indicating light, and the charging indicating unit 15 for alerting the charging information of switching to the last battery by blinking the indicating light; a battery module 2 being a single rechargeable battery (such as the lead acid, nickel-hydrogen, lithium, fuel battery, or any electric storage and discharge components) being connected to the central control module in series or in parallel for the control; an output module 3 being the loading end of the electric output of the central control module, a memory module 5 being externally connected to the central control module for recording the using status of each battery and also provides the battery module next to the last previous starting battery module as the starting battery module for this time after the battery is fully recharged; a data module 6 being connected to the end of the memory module for inputting the low potential data Voff and the data of the number of cycles X between batteries. All these constitute the basic structure of the present invention.

A preferred embodiment of the present invention comprising a low-voltage detecting unit 11 as the switch between batteries for timely controlling the output module 3, a count detecting unit 12 for monitoring the number of times of the previous battery cycle switching output routes to assure that the battery is fully used up before switching to the next battery module and also working with the voltage indicating unit 13 to timely turn on or off the indicating light to show whether or not the battery is used up, a charging indicating unit 15 for alerting the warning information by blinking if the battery switches to the last battery module, which provides users with the correct information about the remaining energy of the battery. When a battery is used up and recharged, the memory module 5 will update the order of cycle between the batteries so that the battery modules can be evenly charged and discharged. Furthermore, if one of the battery modules is used up earlier, then the low-voltage detecting unit will skip that particular battery module and continue the cycle switching until such battery is replaced in order to assure the maximum utility of the batteries and timely indicate the cycle switching of the battery output. The present invention attains the effects of fully charging the battery and protecting the performance of its life.

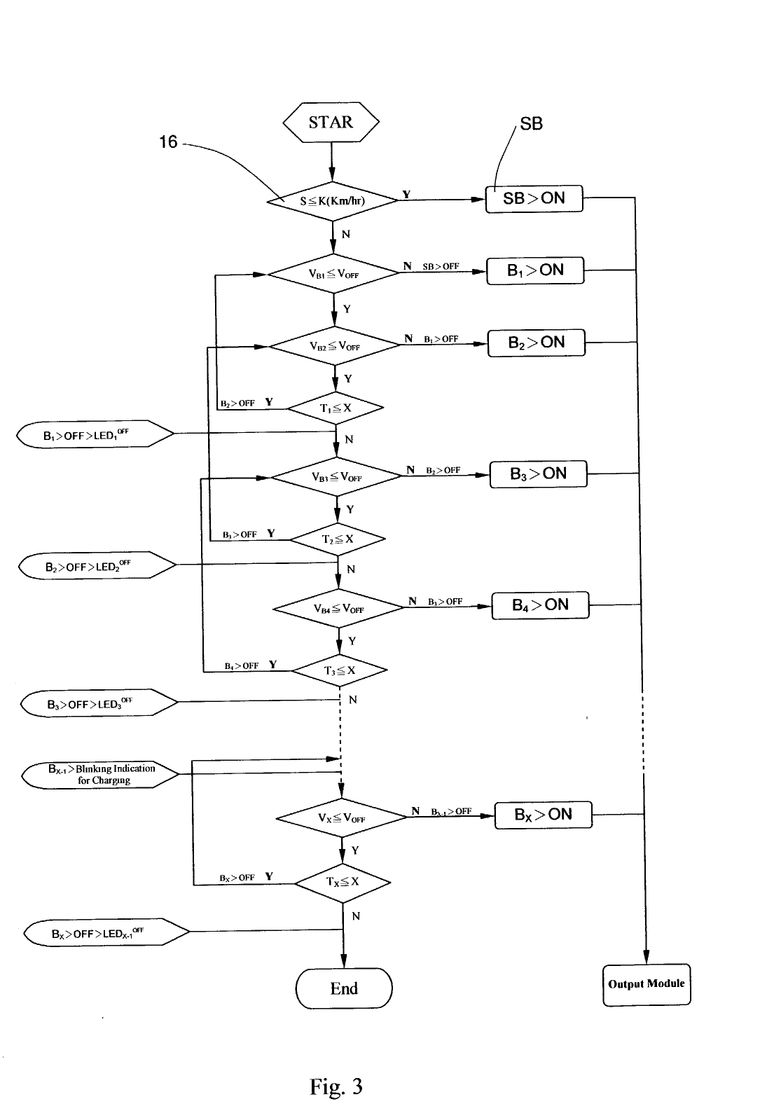

Please refer to FIG. 3. According to the foregoing structure, the central control module 1 is externally connected to a lead acid battery SB used for starting a motor vehicle or motorcycle, and the central control module further comprises a speed detecting unit 16 for measuring the starting speed if it goes beyond the predetermined value K and switches the electric power to the battery module for the power supply for the continual driving of the motor vehicle or motorcycle. The present invention copes with the electronic products that require the timely expansion for preparatory control and thus further improves the value of industrial application.

While the invention has been described by means of specific embodiments, numerous modifications and variations could be made thereto by those skilled in the art without departing from the scope and spirit of the invention set forth in the claims.

What is claimed is:

1. A cycle battery output control device, comprising at least a central control module, a battery module, an output module, a memory module, and a data module; wherein:
the central control module, further comprising a plurality of low-voltage detecting units, a plurality of count detecting units, a plurality of voltage indicating units and a charging indicating unit; said plurality of low-voltage detecting unit being serially connected to a circuit for said plurality of count detecting units serially connected to each of the low-voltage detecting unit; said plurality of voltage indicating units being separately connected in series in front of each low-voltage detecting unit, and the charging indicating unit being individually disposed in front of the last low-voltage detecting unit;
the battery module, being a plurality of single rechargeable battery, each being serially connected to a side of the plurality of the low-voltage detecting units of the central control module for the control;
the output module, being the loading end of the electric output connected in parallel to the plurality of battery modules in the central control module;
the memory module, externally connected to the central control module for recording the using status of each battery and providing the battery next to the previous starting battery as the starting battery of the current cycle;
the data module, being an eternal memory end for inputting the low potential data and the data of the number of cycles between batteries;
such that the foregoing arrangement utilizing the low voltage detecting unit as the switch between batteries for timely controlling the output module; the count detecting unit for monitoring the entire cycle to assure the maximum utility of the electric energy stored in the previous battery; working with the voltage indicating unit and the charging indicating unit to timely provide an alarm information and give users correct information about the actual remaining energy of the battery; charging the battery according to the sequence stored in the memory module to evenly charge and discharge each battery to assure the maximum utility and timely output the cycle switching of the battery in order to fully charge the battery and protect life of the battery and attain the optimal performance.

2. A cycle battery output control device as claimed in claim 1, wherein said central control module being externally connected in series to a lead acid battery and adding a detecting unit for switching the electric power to the battery module provided the measured value by the detecting unit exceeding a predetermined value, such that the motor vehicle continues its driving.

3. A cycle battery output control device as claimed in claim 1, wherein said battery module being an object selected from the collection of a lead acid battery, a nickel-hydrogen battery, a lithium battery, a fuel battery, and a device capable of storing and discharging electric energy.
